(19) United States
(12) Patent Application Publication
(10) Pub. No.: US 2005/0072147 A1
(43) Pub. Date: Apr. 7, 2005

(54) Micro-fluidic actuator

(76) Inventors: Robert W Hower, Farmington Hills, MI (US); Hal C. Cantor, Farmington HIlls, MI (US); Jason R Mondro, Farmington Hills, MI (US)

Correspondence Address: Kenneth I Kohn;Kohn & Associates, Suite 410, 30500 Northwestern Highway, Farmington Hills, MI, 48334, US

(21) Appl. No.: 10/362,343

(22) PCT Filed: Aug. 31, 2001
(86) PCT No.: PCT/US01/27327

Related U.S. Application Data
(60) Provisional application No. 60/229,427, filed on Aug. 31, 2000.

(51) Int. Cl. F02B 29/00

(52) U.S. Cl. 60/508

(57) ABSTRACT

An insulation displacement connector device includes a base body, with a cutting clamp mounted on the base body and a closing element which may be displaced relative to the base body. The base body including an operating volume into which an operating tool may be introduced. The operating tool may be pivoted in a pivoting direction within the operating volume. The closing element may thus be moved between an open and a closed position. The closing element defines the operating volume on one side viewed from the pivoting direction.

### BACKGROUND OF THE INVENTION

1. Technical Field

The present invention relates to a low power micro-actuator-that utilizes planar fabrication technologies to generate relatively large out of plane deflections utilizing a device that requires with very little external micro-machining, while maintaining compatibility with complementary metal-oxide-semiconductor (CMOS) and other planar semiconductor technologies.

2. Background Art

An actuator that produces out of plane movement is necessary for many chip-scale (1 mm² to 1 cm²) applications. Some of these applications include: movement of small volumes of liquid using a micro-fluidic peristaltic pump, valving of solutions to deliver different chemicals to an area on a chip, mixing of solutions in a microscopic chamber, as well as through the attachment to other devices like cilia, fans, or other devices to produce out of plane motion for a silicon micro-machined chip.

Typically, actuators are the driving mechanism behind pumps that force fluid through a passageway, channel, port, or the like, and can possibly function as valves in micro-fluidic devices. These actuators work by various types of actuation forces applied to a flexible mechanism, valve or other similar device. Actuation occurs through methods using various forces such as electrostatic, piezoresistive, pneumatic, electrophoretic, magnetic, acoustic, and thermal gas expansion.

Electrostatic actuation of a membrane is one of the fastest methods for pumping solutions through a system. Piezoresistive actuation is also very fast, utilizing hybrids of thick and thin films to produce a resonant structure affecting pumping of solutions. While these devices exhibit very fast actuation rates, they require very high voltages, from 100V to 200V, and 50V to 500V respectively.

Additionally, electrostatic and piezoresistive actuation require specialized valves that direct fluid flow in a particular direction. As a result, these valves require three chips to be separately machined and bonded together to produce the device.

Pneumatic actuation requires an external pressurized gas source to actuate the membranes that cause fluid flow. While this method is feasible in a laboratory setting where pressurized gas is available, it is impractical for in-the-field utilization.

Electrophoretic actuation utilizes electrodes within a solution to impart a motive force to charged molecules within the solution. Neutral molecules are then ‘dragged’ along with the charged particles. This method is amenable to size reduction; however, it does have critical side effects such as the chromatographic phenomenon that causes a separation of molecules based upon charge. Additionally the high voltages necessary to induce fluid transport are incompatible with standard CMOS circuitry.

Ultrasonic actuation occurs through flexural plate waves. This methodology however, is inefficient and causes mixing due to enhanced diffusion.

Thermal gas expansion relies on the expansion of trapped air in the system to move fluid through the conduits 56. This is accomplished by selectively producing hydrophobic and hydrophilic regions on the chip.

The devices from these previous bodies of work lack the ability to cost-effectively add integrated sensors or circuitry to the devices. Integrating circuitry incorporated into the micro-fluidic devices reduces: (1) the need for costly instrumentation, (2) the overall power consumption of the system, and (3) the complexity of the control signals and mechanisms. Additionally, integrated circuitry allows for the addition of chemical and physical sensor arrays, and for connection to telemetry systems for remote communication with external devices.

Most, if not all, of the micro-fluidic actuators are produced on structures that are not planar. (See, U.S. Pat. Nos. 5,962,081 and 5,726,404). Various other efforts are also underway to build miniature valves and pumps in silicon for micro-fluidics. It has been difficult to produce good sealing surfaces in silicon, and it turns out that these valves, although in principle can be mass-produced on a silicon wafer, require expensive packaging to be utilized. Consequently, such micro-fluidic components cannot be considered inexpensive and/or disposable. In addition, these micro-fluidic pumps and valves must be interconnected into systems including sensors, electronic controls, telemetric circuitry, etc. such that the interconnection becomes expensive.

Accordingly, it would therefore be useful to develop a micro-actuator that is low power, planar, and overcomes all of the problems of the prior art.

### SUMMARY OF THE INVENTION

According to the present invention, there is provided a micro-fluidic actuator including a closed cavity, flexible mechanism defining a wall of the closed cavity, and expanding mechanism disposed in the closed cavity. Specifically, the flexible mechanism deflects upon the application of pressure thereto and the expanding mechanism selectively expands the cavity and thereby selectively flexing the expanding mechanism. Additionally, there is provided an actuator that is compatible with CMOS and other planar technologies that can produce out of plane deflections for use in micro-devices. Moreover, the actuator utilizes the selective vaporization of a trapped liquid under a flexible membrane to produce large deflections of the membrane thereof.

### DESCRIPTION OF THE DRAWINGS

Other advantages of the present invention are readily appreciated as the same becomes better understood by reference to the following detailed description when considered in connection with the accompanying drawings wherein:

FIG. 1 is a cross-sectional schematic view of an embodiment the micro-fluidic actuator with approximate dimensions;

FIG. 2 is a graph showing the temperature profile of each layer identified in FIG. 1;

FIG. 3 is a graph showing the temperature profile through the cross section of the device;

FIG. 4 is a CAD layout of the micro actuator of the present invention;

FIGS. 5A and B show the pressure and temperature curve fitting for steam;

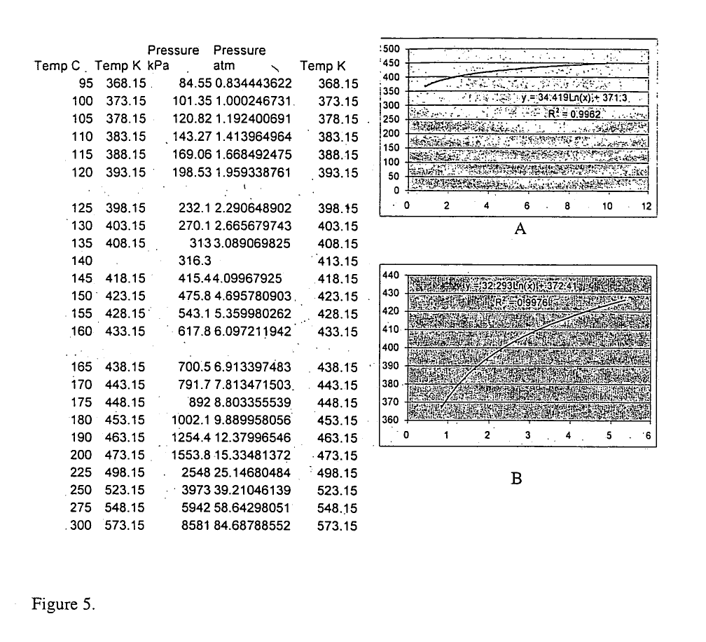

FIG. 6 shows three micro-fluidic actuators in succession thereby creating a micro-fluidic pump; and

FIG. 7 is a cross-sectional view of the actuator of the present invention.

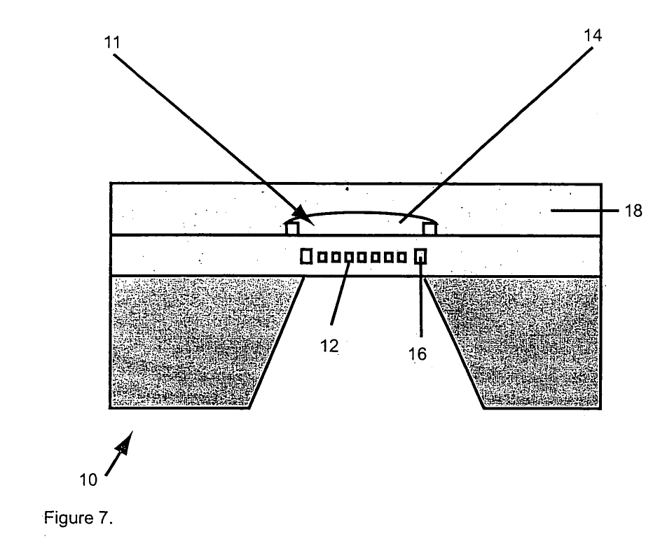

### DETAILED DESCRIPTION OF THE INVENTION

Generally, the present invention provides for a micro-fluidic actuator 10 including a closed cavity 11, flexible mechanism 18 defining a wall of the closed cavity 11, and expanding mechanism 14 disposed within the closed cavity. The flexible mechanism 18 deflects upon the application of pressure thereto and the expanding mechanism 14 selectively expands the cavity and thus flexible mechanism 18 and thereby selectively flexing the expanding mechanism 14.

The present invention has numerous applications and uses. It is well suited for use in various micro devices and systems. For instance, the present invention is designed for use with various micro-systems for use in valves, pumps, microvilli, micro fans, and any other similar micro device known to those of skill in the art. The present invention can be passive and be connected to external circuitry or can be active and use integrated circuitry. Additionally, the present invention can be connected to various accessory devices such as telemetric transmitters, GPS systems to monitor location, audible alarm devices triggered by presence or absence of materials in fluids, solid-state sensors for analysis of fuel cell effluent or biological samples, and any other similar accessory devices known to those of skill in the art.

The present invention can be used as part of micro fluidic systems that monitor minute samples such as tears, saliva, urine, interstitial fluids, and the like. The present invention can also be used in devices that detect toxic materials such as engine fuels, methanol, chemical warfare weapons, and neurotoxins, biological markers such as blood electrolytes, blood glucose, therapeutic drugs, drugs of abuse, pesticides, herbicides, and hormones, and any other similar compound or substance known to those of skill in the art. Additionally, the present invention can be used in micro hydraulic systems, lubrication devices, fuel cells such as direct methanol fuel cells, microvilli systems, micro fans, and other similar devices known to those of skill in the art.

The present invention is aimed to work under a variety environmental of conditions. For instance, they can function at any temperature range, but typically work in ranges of 10° C. to 90° C. Additionally, the present invention functions in various atmospheric pressures such as 0.1 ATM to 3.00 ATM.

The term “actuator” as used herein is meant to include, but is not limited to, a device that causes something to occur. The actuator 10 activates the operation of a valve, pump, villi, fan, blade, or other microscopic device. Typically, the actuator 10 of the present invention affects fluid flow rates within a chamber.

The term “closed cavity” 11 as used herein is meant to include, but is not limited to, a sealed cavity that contains a liquid or solid expanding mechanism 14 that is expanded or vaporized to generate expansion or actuation of a flexible mechanism 18. The closed cavity 11 must be completely sealed in order to contain the expansion therein, and must be flexible on at least one side.

The term “expanding mechanism” 14 as used herein is meant to include, but is not limited to, a fluid 14 capable of being vaporized and condensed within the closed cavity 11 enclosed by the flexible mechanism 18. The expanding mechanism 14 operates upon being actuated or heated. The expanding mechanism 14 includes, but is not limited to, water, wax, hydrogel (solid or non-solid), hydrocarbon, and any other similar substance known to those of skill in the art. Condensation of the expanding mechanism 14 occurs when the heat, which is generated to induce expansion of the expanding mechanism, is removed by a surrounding medium such as a gas, liquid or solid. Then, once condensation occurs, contraction of the flexible-mechanism takes place.

The term “flexible mechanism” 18 as used herein is meant to include, but is not limited to, any flexible mechanism 18 that is capable of expanding and contracting with the vaporization and condensation of the expanding mechanism 14. The flexible mechanism 18 must be able to stretch without breaking when the expanding mechanism 14 is vaporized. The flexible mechanism 18 is made of any material including, but not limited to, silicon rubber, rubber, polyurethane, PVC, polymers, combinations thereof, and any other similar flexible mechanism known to those of skill in the art.

The term “heating mechanism” 12 as used herein is meant to include, but is not limited to, a heating device 12 that is incorporated with the actuator 10 of the present invention. The heating mechanism 12 generates heat to induce expansion of the expanding mechanism 14. The heating mechanism 12 is disposed adjacently to the flexible mechanism 18 in order to turn on and off and maintaining on and off selective expansion of the expanding mechanism 14. The heating mechanism 12 can be powered using any power source known to those of skill in the art. In an embodiment, the heating mechanism 12 is powered by a battery. However, both AC and DC mechanisms are used to minimize power requirements. Generally, the heating mechanism 12 is formed of materials including, but not limited to, polysilicon, elemental metal, silicide, thermocouple, or any other similar heating elements known to those of skill of the art. Moreover, the heating mechanism 12 is disposed within a medium such as SiO₂ or other solid medium known to those of skill in the art.

The term “temperature sensor” as used herein, is meant to include, but is not limited to, a device designed to determine temperature. The temperature sensor is made from material including, but is not limited to, polysilicon, elemental metal, silicide, and any other similar material known to those of skill in the art. Typically, the temperature sensor is situated within or near the heating element of the heating mechanism 12.

The actuators 10 of the present invention can be specifically used in micro-fluidic valves or peristaltic pumps. The micro-fluidic valves have various pressures and temperatures required for their actuation. The peristaltic pump is selectively controlled and actuated through an integrated CMOS circuit or computer control, which evaluates physical layout, actuation timing, and electrical current and heat generation/dissipation requirements for actuation. Integration of control circuitry is important for the reduced power requirements of the present invention. In one particular embodiment for example, sensors and circuitry responsible for monitoring the effluent of a fuel cell with concomitant control of the micro-fluidic fuel-delivery system to increase or decrease the flow rate of fuel is designed. This ensures optimal fuel utilization in the device. Closed loop feedback provides the basis of automated adjustment of circuitry within the micro actuator.

In one embodiment of the present invention, the actuator 10 includes a closed cavity 11, flexible mechanism 18, and expanding mechanism 14. Fabrication of actuators 10 is accomplished by generating electron-beam and/or optical masks from the CAD designs of the micro-fluidic system. Then, using solid-state mass production techniques, silicon wafers are fabricated and the flexible mechanisms 18 for the actuators subsequently are placed on the chips.

In the device without integrated circuitry, the control circuitry is produced on external breadboards and/or printed circuit boards. In this manner, the circuitry is easily, quickly and inexpensively optimized prior to miniaturization and incorporation as CMOS circuitry on-chip that can be controlled manually, or through the use of a computer with digital and analog output. Optimized CMOS circuitry, modeled utilizing T-Spice pro (Tanner, Calif.) solid state MEMS and CMOS design and simulation tools, is integrated into the active device making it a stand-alone functional-unit.

Using an arbitrary wave-form generator, and/or computer controlled digital-to-analog (d/a) and analog-to-digital (a/d) PCI computer cards (for example, the PCIMIO16XH, National Instruments) the optimal operating parameters (i.e., stimulatory waveform patterns) are configured to generate peristaltic pumping action. Electronic control of the actuators 10 is optimized to maximize flow rates, maximize pressure head, and minimize-power utilization and heat generation. Another parameter that is evaluated includes the temperature profile of the medium being pumped. To minimize power consumption and heat generation, a resistor-capacitor circuit is utilized to exponentially decrease the voltage of the sustained pulse. Further, computer initiation and clocking of the circuitry provide control of the second-generation actuators.

An e-prom is also included on-chip to provide digital compensation of resistors and capacitors to compensate for process variations and, therefore, improve the process yield. Electrical access/test pads are designed into the chips to allow for the testing of internal nodes of the circuits. Using the results from the empirical testing, optimization of the system components occurs. After verifying and optimizing the functionality of the on-chip circuitry and the optimal functionality of the actuators, the designs are reworked into a monolithic structure.

The flexible mechanism 18 deflects upon the application of pressure thereto. In one embodiment, the flexible mechanism 18 is screen-printed over the expanding mechanism 14 utilizing an automated screen-printing device, a New Long LS-15TV screen printing system. The flexible mechanism 18 is very elastic and expands many times its initial volume as the expanding mechanism 14 under the flexible mechanism is vaporized. Due to the large deflection, it is possible to completely occlude a micro-channel with this flexible mechanism 18, hence providing the functionality of an electrically actuated microscopic valve. The present invention can also apply flexible mechanism 18 with syringe or pipette devices or spin coat it on the entire wafer. Photo curable membrane can also be used to pattern the flexible mechanism 18 on the wafer.

A wide variety of commercially available polymers can be utilized as the flexible mechanism 18, including, but not limited to: Polyurethane, PVC, and silicone rubber. The actuator flexible mechanism 18 must possess elastomeric properties, and must adhere well to the silicon or other substrate surface. A material with excellent adhesion to the surface, as well as appropriate physical properties, is silicone rubber.

In an embodiment of the present invention, the flexible mechanism 18 is made of silicone rubber. The silicone rubber can be dispensed utilizing automated dispensing equipment, or can be screen-printed directly upon the silicon wafer. Screen printing methods have the advantage that the entire wafer containing hundreds of pump and valve actuators 10 can be produced at once. By varying the amount of solvent in the silicone rubber, the flexible mechanism 18 thickness and its resulting physical force characteristics can be precisely controlled.

The flexible mechanism 18 can serve the dual purpose of actuation as well as serving as the bonding material used to attach the liquid flow channels too the silicon chip containing the actuators 10. By covering the entire area of the chip with the flexible mechanism 18, with the exception of the sensing regions and the bonding pads, the glass or plastic channels can be “glued” to the actuator 10 containing silicon chip. This method provides additional anchoring and strength to the actuation flexible mechanism 18, and allows the actuation area to encompass the entire actuation chamber 20. The only drawback to this method is protein and/or steroid adsorption onto the micro fluidic conduits 56. However, with proper flexible mechanism 18 selection and chemical treatment, molecular adsorption can be minimized, or a second, thin, inert layer can be used to coat the flexible mechanism 18.

The expanding mechanism 14 selectively expands the cavity 11 defined by the flexible mechanism 18 thereof and thereby selectively flexes the flexible mechanism 14. The expanding mechanism can be made of various materials. In one embodiment, the expanding mechanism is a hydrogel material, which contains a large amount of water or other hydrocarbon medium, which is vaporized by the underlying heating mechanism. In this embodiment, the volume of hydrogel needed to produce the desired actuation and pressure for the flexible mechanism 18 is approximately 33 pL. With this design, approximately 97% of the energy generated by the heating mechanism 12 is transferred into the hydrogel for evaporation.

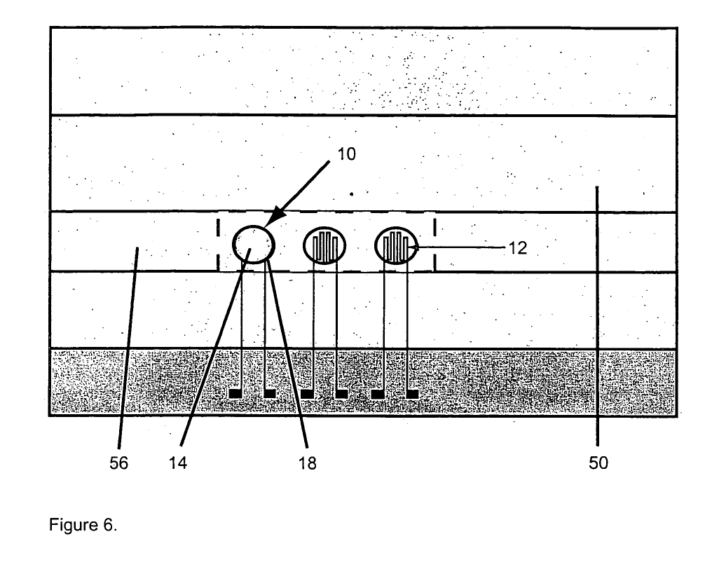

In an embodiment of the present invention, the actuator 10 can be used in a micro-fluidic pump. The micro-actuator 10 is designed such that it can be fabricated using minimal micro-machining and employs planar fabrication techniques. The micro-fluidic actuator 10 is based upon electrically activated pneumatic actuation of a micro-screen-printed or casted flexible mechanism 18. The peristaltic pump generally includes three actuators 10 placed in series wherein each actuator 10 creates a pulse once it is activated. By working in tandem, the actuators 10 peristaltically pump fluids. FIG. 6 details a configuration that contains three micro-fluidic actuators 10 responsible for the pneumatic pumping action. The optimal firing order and timing for each actuator 10 depends upon the requirements for the system and are under digital control to create the peristaltic pumping action.

The advantage of pneumatic actuation is that large deflections can be achieved for the flexible mechanism 18. To actuate the flexible mechanism 18, a vaporizable fluid 14 is heated and converted into vapor to provide the driving force. Utilizing an integrated heating mechanism 12, the expanding mechanism 14 is vaporized under the flexible mechanism 18 to provide the pneumatic actuation. This actuation occurs without the requirement of utilizing external pressurized gas.

The liquid fluid being pumped serves the purpose of acting as a heat sink to condense the gas back to liquid and hence return the flexible mechanism 18 to is relaxed state when the heating mechanism 12 is inactivated. A temperature sensor 16 is integrated adjacent to the actuator 10 to monitor the temperature of the micro-fluidic integrated heating mechanism 12 and hence, expanding mechanism 14.

The heating-mechanism 12 requires very low power to achieve sufficient temperatures for fluid vaporization. As an example, miniature inkjet nozzles that require temperatures in excess of 330° C., utilize 20μ second pulses of 16 mA to heat the fluid and fire an ink droplet. Considerably lower power would be required to vaporize the liquid in the present micro-fluidic pump application. In the field, it is necessary to utilize low power devices and circuitry to conserve energy and allow the use of very small, lightweight film or button batteries.

Once the heating mechanism 12 is activated, vaporization of the expanding mechanism 14 takes place. The expanding mechanism 14 component imposes a pressure upon the flexible mechanism 18 causing it to expand and be displaced above the heating mechanism 12 and reduce the volume of the chamber 20. This methodology can be utilized to displace fluid between the flexible mechanism 18 and the walls of the chamber 20 (pumping action), to occlude fluid flow through the chamber 20 (valving action), to provide direct contact to the glass substrate to effect heat transfer, or to provide the driving force for locomotion of a physical device (i.e., as in a walking caterpillar and/or a swimming paramecium with a flapping flagella, in which case the glass chamber 20 encompassing the micro-actuator 10 would not be used).

The heat flux through each of the layers composing the device is calculated using existing boundary conditions. The temperature required to vaporize the expanding mechanism 14 varies according to the physical and chemical properties of the expanding mechanism 14 itself. Due to the differences in heat transfer through liquid versus gas, approximately twice as much heat flux travels through the device when the hydrogel is all liquid compared to all vapor. In order to reduce heat dissipation into the medium being pumped, while the hydrogel is in the liquid state, the heating mechanism 12 is quickly ramped to the temperature required to vaporize the liquid. Once the hydrogel is vaporized, heat transfer to the medium being pumped is minimized.

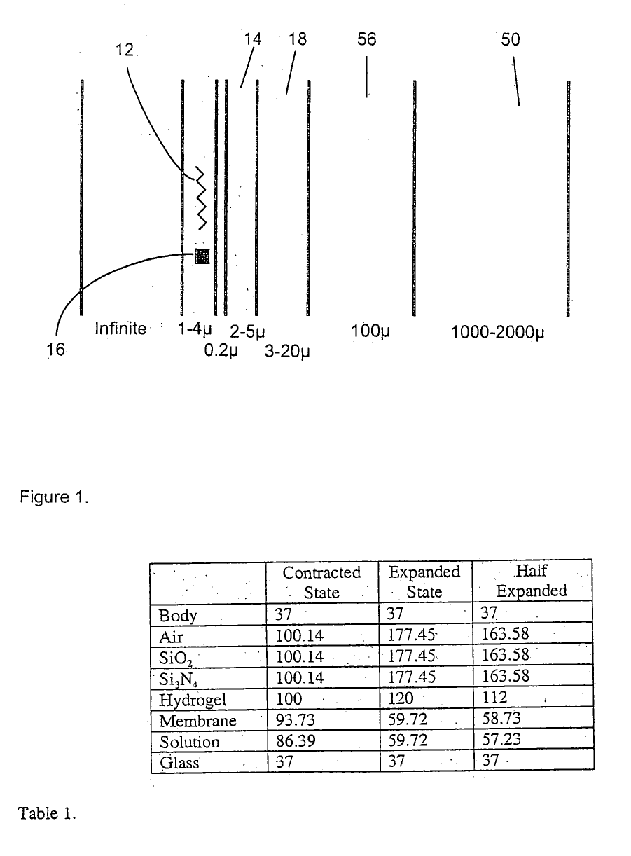

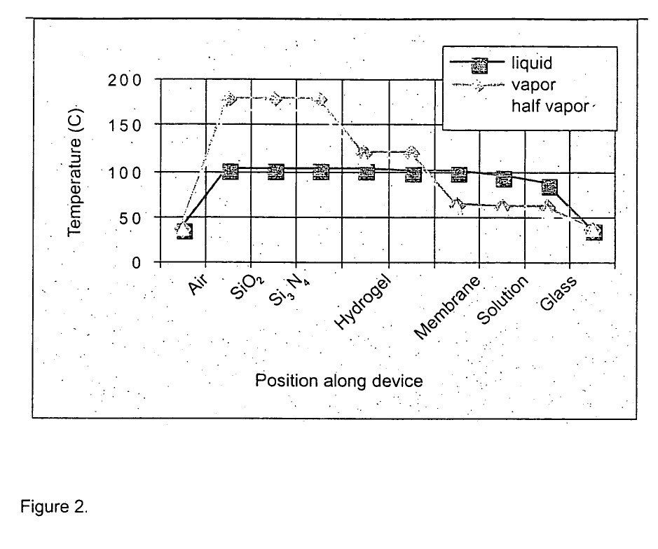

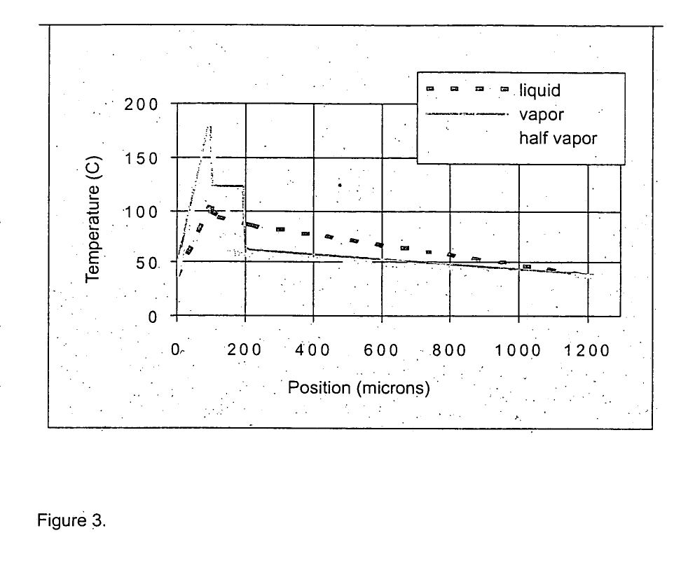

It is assumed that the temperature on both sides of the SiO₂ that encapsulates the heating mechanism 12 is constant, and that heat flux in each direction is dependent upon the heating mechanism 12 temperature and the resistance to heat flow either through the device or to the air from the backside. A schematic of the cross section of the entire device is provided in FIG. 1. Steady state heat flow through the entire actuator 10, for the fully actuated state, the intermediate state, and the resting state are modeled. The temperature profiles are presented graphically in FIGS. 2 and 3, and in a tabular format in Table 1. In order to isolate the heater, a cavity is etched in the backside of the wafer, providing thermal isolation.

In one embodiment,.the temperature of the saturated liquid hydrogel, at 1 ATM, is assumed to be 100° C. The heat flux to the air, through the back of the heating mechanism 12, is calculated to be 1263 W/K-m². The total heat flux through the device is calculated to be 46,995 W/K-m² with a total flux from the heating mechanism 12 of 47,218 W/K-m² (i.e. 97% efficiency of focused heat transfer). In this embodiment, the temperature of the inactive state hydrogel varies between 86° C. and 94° C.

The temperature of the activated, vapor state hydrogel is approximately 120° C., which is the saturation temperature for steam at 2 ATM. The heat transfer coefficient for convection can be calculated directly from the thermal conductivity. The heat flux to the air through the back of the heating mechanism 12 is 2818 W/K-m². The heat flux through the device is 21, 352 W/K-m² with a total flux from the heating mechanism 12 of 24,170 W/K-m². When the aqueous component of the hydrogel is completely in the vapor state, there is no fluid 14 in the channel and the thin film of solution between the flexible mechanism 18 and the glass is approximately at 60° C. These values and calculations vary according to the type of actuator, valve, pump, and micro device being used.

The temperature distribution through each layer of the device is modeled using linear methods. The actual temperature distribution is exponential, but the temperatures at the interface of each layer are identical to that predicted by the linear model. FIG. 2 depicts the temperatures between each layer. FIG. 3 depicts how the temperature varies through the device at a specific distance. The blue line (square markers in FIG. 2, tight dashed line in FIG. 3) indicates the temperature profile of the fully contracted (liquid state) actuator 10, while the red line (diamond markers in FIG. 2, solid line in FIG. 3) indicates fully expanded (vapor state). The green line (triangle markers in FIG. 2, loose dashed line in FIG. 3) represents the temperature profile of the partially expanded actuator 10.

In an embodiment of the present invention, the volume of liquid hydrogel is determined based on the volume of vapor needed to expand the flexible mechanism 18 completely at 2 ATM using the ideal gas law. This assumption is valid because the temperatures and pressures are moderate. The volume of liquid hydrogel necessary to achieve this volume of gas at this pressure, assuming the hydrogel is 10% water and all of the water is completely evaporated, is 0.033 nL. Cylindrically shaped sections of hydrogel are utilized within the actuator 10. This shape has been chosen to optimize encapsulation by the actuator flexible mechanism 18. The cylinders have either a diameter of approximately 140 μm and a height of 2.14 μm, or a diameter of 280 μm with a height of 0.54 μm (identical volumes, different orientation to the heating element) Of course, the shapes and volumes vary according to the type of expanding mechanism being used. For example, photocurable liquid hydrogels have different parameters.

For flexible mechanism 18 actuation and hydrogel vaporization, it is necessary to raise the temperature of the hydrogel from ambient temperature to the boiling point, 120° C. at 2 ATM. Thermodynamic models indicate that approximately 8.03×10⁻⁷ J of heat transfer is required to raise the temperature of the hydrogel from 37° C. to 120° C. (1.08×10⁻⁷ J) and vaporize all of the water (6.95×10⁻⁷ J). This is consistent with the sum of enthalpy equation.

In another embodiment, for flexible mechanism 18 contraction and hydrogel condensation, it is assumed that all heat dissipation from the activated, vaporized hydrogel, as it condenses, is transferred into the solution being pumped. The calculation for this condensation involves condensing all of the water in the hydrogel plus sub cooling the hydrogel from 100° C. to 90° C. in order to completely contract the actuator 10. Modeling conduction through the actuator 10 flexible mechanism 18 using Fourier's equation provides a flux of 0.0015 J/s and a condensation time of 0.00473 seconds. This represents a worst case scenario, neglecting thermal conduction to the silicon substrate.

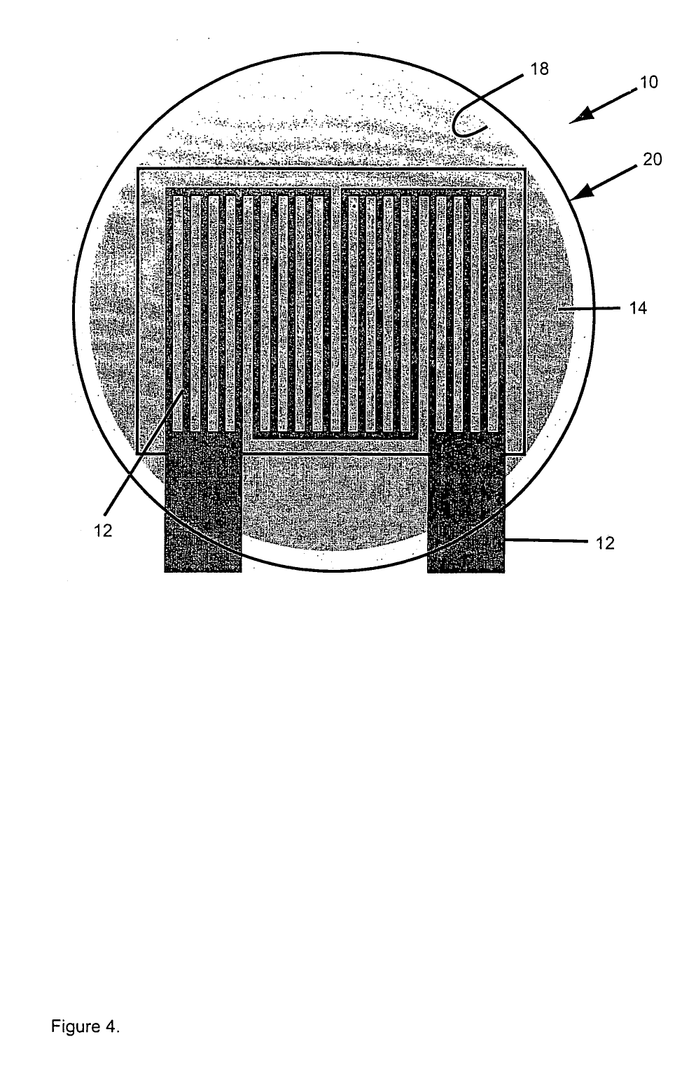

In an embodiment of the present invention, based upon the geometry of the 100 μm tall chamber 20, it is calculated that a circular actuator 10 with a diameter of 300 μm is required to deliver 4.9 nL quantities of liquid per actuation of the flexible mechanism 18. The heating mechanism 12 is laid out as a square that encompasses the majority of the circular hydrogel area without extending past the edge of the chamber 20. Other shapes are also employed, such as circular and triangular layouts to encompass as much of the hydrogel as possible. In order to provide efficient micro-actuation in 150 μs, requirements for the heating mechanism 12 power output and electrical resistance are calculated. To provide the required 777 nJ of energy, the resistance of the poly-silicon heating mechanism 12 is calculated to between 450 to 500Ω, based upon utilizing a 5V power supply. Actuation requires a 150 μs pulse of approximately 11 mA of current, providing the 777 nJ of energy required. In order to achieve a pumping rate of 10 μL/minute, approximately 677 μW of power is required. In previous work, poly-silicon structures at a thickness of 6000 Å, having a resistance of 15 Ω/elemental square have been produced. To provide the required resistance, 5 poly-silicon heating mechanism 12 lines are arranged in parallel (See FIG. 4). The poly-silicon heating mechanism 12 elements have a width of 5 μm. The total resistance of the heating mechanism 12 is 450 Ω.

FIG. 4 is a schermatic CAD layout of an actuator 10 with a heating mechanism 12. In this case, the heating mechanism 12 is poly-silicon, but can be any similar material or mechanism such as direct metals known to those of skill in the art. Because of its high thermal conductivity, the silicon substrate acts as a heat sink. To reduce thermal conduction to the silicon substrate, a window in the silicon, located beneath the heating mechanism 12, provides the hydrogel with an isolated platform. This window is only slightly larger than the heating mechanism 12 to maintain some thermal conduction to the substrate. After the actuator 10 is energized, thermal conduction to the silicon provides decreased time to condense the liquid in the hydrogel. This decreases constriction time and provides improved pumping rates. If the window is significantly larger than the actuator 10, there is no heat conduction path to the substrate, hence increasing condensation time and decreasing the maximal flow rate.

In one embodiment, the hydrogel is presented as a cylinder with diameter of 280 μm and height of 0.5-1 μm. The actuation chamber 20 encompasses the entire cavity etched in the glass substrate. The cavity can be redesigned before mask generation to account for undercut of the glass. As glass is chemically etched, the etchant undercuts the mask making the cavity larger than the photo mask size.

Fabrication of this device is based upon the development of a process flow. The fabrication process utilizes bulk silicon micro-machining techniques to produce the isolation windows, and thick film screen printing techniques, spin coating, mass dispensing, or mechanical dispensing of actuation membranes.

A polymeric hydrogel (or hydrocarbon) can be utilized to provide a physically supportive structure that withstands the application of flexible mechanism 18 as well as to provide the aqueous component required for actuation. Several commercially available materials meet these requirements. A hydrogel is selected that contains approximately 30% aqueous component that vaporizes near 100° C. Several promising materials have been identified, each of which is examined for suitability in this application, including, but not limited to, hydroxyethylmethacrylate (HEMA) and polyvinylpyrrolidone (PVP). Additionally, hydrocarbons can be used since they possess lower boiling points than aqueous hydrogels, and therefore require less power to effect pneumatic actuation.

Dispensing hydrogel (or hydrocarbon) into the desired location is accomplished utilizing one of three methods. First, a promising method for patterning the hydrogel is to utilize a photopatternable-crosslinking hydrogel. The hydrogel is cross-linked by incorporating an UV photo-initiator polymerizing agent within the hydrogel that cross-links when exposed to UV radiation. Using this technique, the hydrogel would be evenly spun on the entire wafer using standard semiconductor processing techniques. A photographic mask is then placed over the wafer, followed by exposure to UV light. After the cross-linking reaction is completed, excess (non-cross-linked hydrogel) is washed from the surface.

The second method involves dispensing liquid hydrogel into well-rings created around the poly-silicon heating mechanism 12. These wells have the ability to retain a liquid in a highly controlled manner. Two photopatternable polymers have been utilized to create microscopic well-ring structures, SU-8 and a photopatternable polyimide. These well-rings can be produced in any height from 2 μm to 50 μm, sufficient to contain the liquid hydrogel. Once the hydrogel solidifies, flexible mechanisms can be deposited over theme. This can be accomplished in an automated manner utilizing commercially available dispensing equipment.

In a third alternate method, a pre-solidified hydrogel is used that has been cut into the desire size and shape. This is facilitated by extruding the hydrogel in the desired radius and slicing it with a microtome to the desired height, or by spinning the hydrogel to the desired thickness and cutting it into cylinders of the desired radius. Utilizing micro-manipulators, the patterned gel is placed in the desired area. This process can also be automated.

It is assumed that the temperature on both sides of the SiO₂ that encapsulates the heating mechanism is constant, and that heat flux in each direction is dependant upon the poly-silicon heating mechanism temperature and the resistance to heat flow either through the device or to an air pocket on the heating mechanism backside. A schematic of a cross section of the actuator device is provided in FIG. 4. Steady-state heat flow through the entire actuator, for the fully actuated state, the intermediate state, and the resting state are modeled. This data are calculated for the static case during which time no fluid flow is occurring or is unactuated (i.e. steady-state; the system is poised at 100 C., waiting to be initiated). The fluid temperature is greater for the contracted state since the liquid hydrogel conducts heat at a greater rate than water vapor. Once fluid flow is initiated, the temperature of the solution is raised by only a few degrees Celsius. The temperature profiles are presented graphically in FIGS. 2 and 3, and in a tabular format in Table 1.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the described invention, the invention can be practiced otherwise than as specifically described.

1. A micro-fluidic actuator comprising:
a closed cavity;
flexing means defining a wall of said cavity for deflecting upon an application of pressure thereto; and
expanding means disposed in said cavity for selectively expanding said cavity and thereby selectively flexing said expanding flexing means.

2. The micro-fluidic actuator according to claim 1, wherein said flexing means is made from material selected from the group consisting essentially of silicon rubber, rubber, polyurethane, PVC, polymers, and combinations thereof.

3. The micro-fluidic actuator according to claim 1, wherein said expanding means includes vaporizable fluid selected from the group consisting essentially of water, wax, hydrocarbon, and hydrogel.

4. The micro-fluidic actuator according to claim 1 further comprising heating means disposed adjacent to said flexible means for selectively expanding said expanding means.

5. The micro-fluidic actuator according to claim 4, wherein said heating means includes an integrated heating element made from material selected from the group consisting essentially of polysilicon, elemental metal, and silicide.

6. The micro-fluidic actuator according to claim 4, wherein said heating means includes a temperature sensor made from material selected from the group consisting essentially of polysilicon, elemental metal, and silicide.

7. The micro-fluidic actuator according to claim 4, wherein said heating means is operatively connected to and powered by a battery.

8. The micro-fluidic actuator according to claim 1, further defined as a planar micro-fluidic actuator.
